(19) United States
(12) Patent Application Publication
(10) Pub. No.: US 2023/0089713 A1
(43) Pub. Date: Mar. 23, 2023

(54) QUANTUM DOT COMPOSITE, OPTICAL FILM AND BACKLIGHT MODULE

(71) Applicant: NAN YA PLASTICS CORPORATION, TAIPEI (TW)

(72) Inventors: TE-CHAO LIAO, TAIPEI (TW); CHUN-CHE TSAO, TAIPEI (TW); Ren-Yu Liao, New Taipei City (TW); Guo-Yuan He, TAIPEI (TW)

(21) Appl. No.: 17/870,844

(22) Filed: Jul. 22, 2022

(30) Foreign Application Priority Data
Sep. 13, 2021 (TW) 110133946

(51) Int. Cl. C09K 11/02; C08K 9/04; C08F 222/10; C08F 220/18; C08F 220/36; F21V 8/00

(52) U.S. Cl. CPC C09K 11/025; C08K 9/04; C08F 222/104; C08F 220/1811; C08F 220/36; G02B 6/005; C08K 2201/011; C08K 2201/005; C08F 2800/20

(57) ABSTRACT

A quantum dot composite, an optical film, and a backlight module are provided. The quantum dot composite includes a polymerizable polymer and a plurality of quantum dot particles dispersed in the polymerizable polymer. A particle size of the plurality of the quantum dot particles ranges from 8 nm to 30 nm. Based on a total weight of the polymerizable polymer being 100 wt %, the polymerizable polymer includes: 10 wt % to 30 wt % of a multifunctional acrylic monomer, 8 wt % to 60 wt % of a thiol compound self-assembled on surfaces of the plurality of the quantum dot particles, and 1 wt % to 5 wt % of a photoinitiator.

### CROSS-REFERENCE TO RELATED PATENT APPLICATION

This application claims the benefit of priority to Taiwan Patent Application No. 110133946, filed on Sep. 13, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a quantum dot composite, an optical film, and a backlight module, and more particularly to a quantum dot composite, an optical film, and a backlight module that can be used in a display which converts blue light.

### BACKGROUND OF THE DISCLOSURE

In response to increasing requirements for the color quality of a display, developing displays that have high color saturation and small thickness has become the mainstream trend. Compared with an organic light-emitting diode (OLED), quantum dots have a higher luminous efficiency, a wider color gamut, and a higher color purity. Therefore, much research has been dedicated to the design of an optical film manufactured from a quantum dot material for being used as a backlight source in displays, so as to provide a better experience for viewers.

When the optical film is applied in a backlight module, the quantum dots in the optical film are excited by a light beam generated by the backlight source and generate a light beam with an expected color. However, when energy produced by the backlight source is too strong, the quantum dots can be overly excited and cause saturated quenching due to the Auger effect. Eventually, the color gamut of the backlight module gradually changes. For example, a color gamut of a backlight module that has a blue backlight source will gradually become bluish after saturated quenching of the quantum dots.

As such, a backlight source with a luminance of approximately 3000 cd/m² is generally used in a conventional backlight module, so as to prevent photobleaching. In this way, a service life of the backlight module can be prolonged.

In order to prevent the quantum dots from being quenched, a technology for dispersing the quantum dots in an optical structure has been developed. The optical structure can obstruct blue light in a certain wavelength band, so as to enhance weather resistance of the backlight module. Accordingly, the optical film can be applied in a high-intensity blue light backlight module.

However, the technology of dispersing the quantum dots in the optical structure has a high cost and is unsuitable for mass production. Therefore, how to adjust components of the quantum dot material, so as to enhance its weather resistance and overcome the above-mentioned inadequacies, has become an important issue in the related field.

### SUMMARY OF THE DISCLOSURE

In response to the above-referenced technical inadequacies, the present disclosure provides a quantum dot composite, an optical film, and a backlight module.

In one aspect, the present disclosure provides a quantum dot composite. The quantum dot composite includes a polymerizable polymer and a plurality of quantum dot particles dispersed in the polymerizable polymer. A particle size of the plurality of the quantum dot particles ranges from 8 nm to 30 nm. Based on a total weight of the polymerizable polymer being 100 wt %, the polymerizable polymer includes: 10 wt % to 30 wt % of a multifunctional acrylic monomer, 8 wt % to 60 wt % of a thiol compound self-assembled on surfaces of the plurality of the quantum dot particles, and 1 wt % to 5 wt % of a photoinitiator.

In certain embodiments, each of the quantum dot particles has a core layer and a sheath layer. A thickness of the sheath layer ranges from 2.5 nm to 12 nm.

In certain embodiments, a material of the sheath layer contains cadmium.

In certain embodiments, each of the quantum dot particles further has an alloy layer disposed between the core layer and the sheath layer.

In certain embodiments, the quantum dot particles include red quantum dots with a size ranging from 8 nm to 20 nm and green quantum dots with a size ranging from 11 nm to 30 nm.

In certain embodiments, the quantum dot particles include red quantum dots and green quantum dots, and a weight amount of the green quantum dots is 4 times to 10 times larger than a weight amount of the red quantum dots.

In certain embodiments, a concentration of the quantum dot particles in the quantum dot composite ranges from 4 wt % to 15 wt %.

In certain embodiments, the thiol compound is selected from the group consisting of: 3-mercaptopropionic acid, propyl 3-mercaptopropionate, ethyl 3-mercaptopropionate, butyl 3-mercaptopropionate, 3-mercaptopropionitrile, and any combination thereof.

In certain embodiments, the multifunctional acrylic monomer is selected from the group consisting of: pentaerythritol tetraacrylate, pentaerythritol triacrylate, and any combination thereof.

In certain embodiments, the quantum dot composite further includes a monofunctional acrylic monomer. Based on the total weight of the polymerizable polymer being 100 wt %, an amount of the monofunctional acrylic monomer ranges from 2.5 wt % to 65 wt %. The monofunctional acrylic monomer is selected from the group consisting of: isobornyl acrylate (IBOA), acrylomorpholine (ACMO), and any combination thereof.

In certain embodiments, the quantum dot composite further includes an allyl monomer. Based on the total weight of the polymerizable polymer being 100 wt %, an amount of the allyl monomer ranges from 5 wt % to 20 wt %. The allyl monomer is selected from the group consisting of: diallyl terephthalate, diallyl phthalate, diallyl carbonate, diallyl oxalate, and diallyl isophthalate, and any combination thereof.

In certain embodiments, the quantum dot composite further includes scattering particles. Based on the total weight of the polymerizable polymer being 100 wt %, an amount of the scattering particles ranges from 2 wt % to 10 wt %.

In another aspect, the present disclosure provides an optical film. The optical film includes a quantum dot layer, a first substrate layer, and a second substrate layer. The quantum dot layer is disposed between the first substrate layer and the second substrate layer. The quantum dot layer is formed by solidification of a quantum dot composite. The quantum dot composite includes a polymerizable polymer and a plurality of quantum dot particles dispersed in the polymerizable polymer. A particle size of the plurality of the quantum dot particles ranges from 8 nm to 30 nm. Based on a total weight of the polymerizable polymer being 100 wt %, the polymerizable polymer includes: 10 wt % to 30 wt % of a multifunctional acrylic monomer, 8 wt % to 60 wt % of a thiol compound self-assembled on surfaces of the plurality of the quantum dot particles, and 1 wt % to 5 wt % of a photoinitiator.

In certain embodiments, materials of the first substrate layer and the second substrate layer include polyethylene terephthalate. A thickness of each of the first substrate layer and the second substrate layer ranges from 20 μm to 125 μm.

In certain embodiments, a thickness of the quantum dot layer ranges from 20 μm to 350 μm.

In certain embodiments, the optical film further includes a protection layer. The protection layer is disposed on each of the first substrate layer and the second substrate layer.

In yet another aspect, the present disclosure provides a backlight module. The backlight module includes an optical film, a light emitting unit, a first light guide unit, and a second light guide unit. The optical film includes a quantum dot layer, a first substrate layer, and a second substrate layer. The quantum dot layer has a first surface and a second surface. The quantum dot layer is formed by solidification of a quantum dot composite. The quantum dot composite includes a polymerizable polymer and a plurality of quantum dot particles dispersed in the polymerizable polymer. A particle size of the plurality of the quantum dot particles ranges from 8 nm to 30 nm. Based on a total weight of the polymerizable polymer being 100 wt %, the polymerizable polymer includes: 10 wt % to 30 wt % of a multifunctional acrylic monomer, 8 wt % to 60 wt % of a thiol compound self-assembled on surfaces of the plurality of the quantum dot particles, and 1 wt % to 5 wt % of a photoinitiator. The first substrate layer is connected with the first surface of the quantum dot layer. The second substrate layer is connected with the second surface of the quantum dot layer. The light emitting unit is disposed adjacent to the optical film. The light emitting unit generates a light beam that is projected to the optical film, and an intensity of the light beam is not less than 10000 cd/m². The first light guide unit is connected with the first substrate layer of the optical film. The second light guide unit is connected with the second substrate layer.

Therefore, in the quantum dot composite, the optical film, and the backlight module provided by the present disclosure, by virtue of “a particle size of the plurality of the quantum dot particles ranging from 8 nm to 30 nm” and “the thiol compound being self-assembled on surfaces of the plurality of the quantum dot particles,” the quantum dot composite can have improved weather resistance and can be applied in a display that is used to convert blue light.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a partial cross-sectional side view of a quantum dot composite according to one embodiment of the present disclosure;

FIG. 2 is a partial cross-sectional side view of a quantum dot according to one embodiment of the present disclosure;

FIG. 3 is a partial cross-sectional side view of an optical film according to one embodiment of the present disclosure;

FIG. 4 is a partial cross-sectional side view of the optical film according to another embodiment of the present disclosure; and

FIG. 5 is a schematic side view of a backlight module according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

The present disclosure provides a quantum dot composite, which can be used to manufacture an optical film and a backlight module that contains the optical film. The backlight module is particularly suitable to be applied in a display which converts blue light. The backlight module has good weather resistance. Even when a high-intensity blue light source (10000 cd/m²) is used, quantum dots will not be overly excited and cause saturated quenching.

### First Embodiment

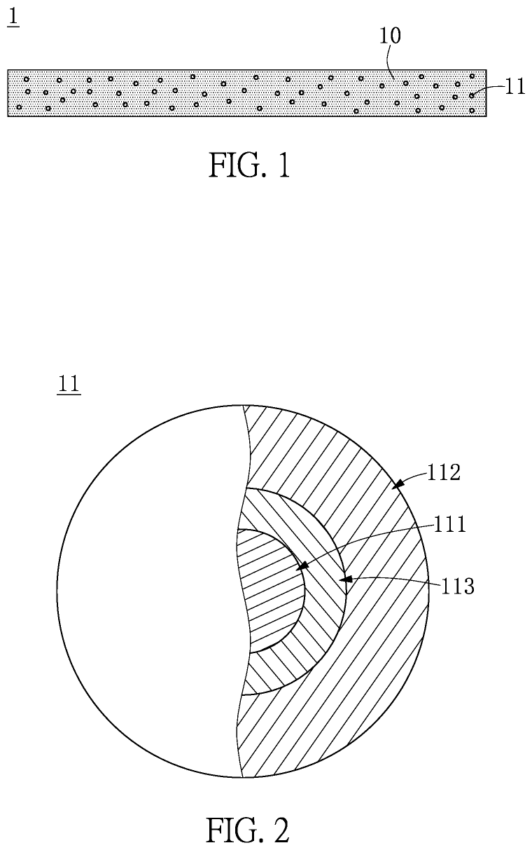

Referring to FIG. 1, the present disclosure provides a quantum dot composite 1. The quantum dot composite 1 includes a polymerizable polymer 10 and a plurality of quantum dot particles 11 dispersed in the polymerizable polymer 10. A particle size of the quantum dot particles 11 ranges from 8 nm to 30 nm. The quantum dot particles 11 can obstruct a part of blue light, thereby reducing absorption of the blue light by the quantum dot particles 11. Accordingly, weather resistance of the quantum dot particles 11 can be enhanced.

Since only a part of the blue light is absorbed by the quantum dot particles 11, an amount of the quantum dot particles 11 can be increased to reach an expected luminous efficiency. Specifically, a concentration of the quantum dot particles 11 in the quantum dot composite 1 ranges from 4 wt % to 15 wt %. In some embodiments, the concentration of the quantum dot particles 11 in the quantum dot composite 1 can be 5 wt %, 6 wt %, 7 wt %, 8 wt %, 9 wt %, 10 wt %, 11 wt %, 12 wt %, 13 wt %, or 14 wt %. However, the present disclosure is not limited thereto.

The plurality of the quantum dot particles 11 can include red quantum dots, green quantum dots, blue quantum dots, or any combination thereof. In an exemplary embodiment, the quantum dot particles 11 include the red quantum dots and the green quantum dots. A weight amount of the green quantum dots is larger than a weight amount of the red quantum dots. Specifically, the weight amount of the green quantum dots is 4 times to 10 times larger than the weight amount of the red quantum dots.

In an exemplary embodiment, a size of the red quantum dots ranges from 8 nm to 20 nm; preferably, the size of the red quantum dots ranges from 10 nm to 18 nm. A size of the green quantum dots ranges from 11 nm to 30 nm; preferably, the size of the green quantum dots ranges from 13 nm to 26 nm.

The quantum dot particles 11 can have a monolayer structure or a core-sheath structure. In an exemplary embodiment, the quantum dot particles 11 have the core-sheath structure. Referring to FIG. 2, the quantum dot particles 11 have a core layer 111 and a sheath layer 112 encapsulating the core layer 111. The core layer 111 can absorb the blue light and convert the blue light into other light beams with different wavelengths. For example, a diameter of the core layer 111 ranges from 2 nm to 5 nm. The sheath layer 112 can obstruct a part of the blue light but cannot absorb the blue light. For example, a thickness of the sheath layer 112 ranges from 2.5 nm to 12 nm. A thick sheath layer 112 can enhance the weather resistance of the quantum dot particles 11. In other embodiments, the thickness of the sheath layer 112 can be any integer between 2.5 nm and 12 nm, such as 3 nm, 5 nm, 7 nm, 9 nm, or 11 nm.

In an exemplary embodiment, the thickness of the sheath layer 112 of the red quantum dots can range from 2 nm and 8 nm. Preferably, the thickness of the sheath layer 112 of the red quantum dots can range from 2.8 nm and 6 nm. The thickness of the sheath layer 112 of the green quantum dots can range from 3 nm and 12 nm. Preferably, the thickness of the sheath layer 112 of the green quantum dots can range from 3.5 nm and 10 nm.

In addition, the quantum dot particles 11 can further have an alloy layer 113. The alloy layer 113 is disposed between the core layer 111 and the sheath layer 112, and functions as a transition layer between the core layer 111 and the sheath layer 112. A metal composition of the alloy layer 113 gradually changes from a metal composition of the core layer 111 into a metal composition of the sheath layer 112 along an outward radial direction. A thickness of the alloy layer 113 ranges from 1 nm and 3 nm. Descriptions provided below are only for illustration purposes, and the present disclosure is not limited thereto.

Materials of the core layer 111 and the sheath layer 112 can be a composite containing elements in Group II-VI, Group II-V, Group III-VI, Group III-V, Group IV-VI, Group II-IV-VI, or Group II-IV-V. The term “Group” refers to the group in the periodic table.

For example, the materials of the core layer 111 and the sheath layer 112 of the quantum dot particles 11 can include CdSe/ZnS, InP/ZnS, PbSe/PbS, CdSe/CdS, CdTe/CdS, or CdTe/ZnS. In an exemplary embodiment, the sheath layer 112 of the quantum dot particles 11 contains cadmium. However, the present disclosure is not limited thereto.

In some embodiments, a ligand is formed on surfaces of the plurality of the quantum dot particles 11, so as to maintain stability of the plurality of the quantum dot particles 11. Specifically, the ligand is selected from the group consisting of: oleic acid, alkyl phosphine, alkyl phosphine oxide, alkyl amines, alkyl carboxylic acid, alkyl mercaptan, and alkyl phosphonic acid. However, the present disclosure is not limited thereto.

Due to a high amount of the quantum dot particles 11, the dispersity of the quantum dot particles 11 in the polymerizable polymer 10 is important. In the present disclosure, by adjusting compositions and contents of the polymerizable polymer 10, the dispersity of the quantum dot particles 11 can be enhanced.

Specifically, based on a total weight of the polymerizable polymer 10 being 100 wt %, the polymerizable polymer 10 includes 10 wt % to 30 wt % of a multifunctional acrylic monomer, 8 wt % to 60 wt % of a thiol compound, 2.5 wt % to 65 wt % of a monofunctional acrylic monomer, 5 wt % to 20 wt % of an allyl monomer, 1 wt % to 5 wt % of a photoinitiator, and 2 wt % to 10 wt % of scattering particles.

An addition of the multifunctional acrylic monomer can increase a crosslink density of the polymerizable polymer 10 after solidification. Specifically, the multifunctional acrylic monomer is selected from the group consisting of: trimethylolpropane triacrylate, ethoxylated trimethylolpropane triacrylate, ditrimethylolpropane tetraacrylate, pentaerythritol tetraacrylate, dipentaerythritol pentaacrylate, and ethoxylated pentaerythritol tetraacrylate. Preferably, the multifunctional acrylic monomer is selected from the group consisting of: pentaerythritol tetraacrylate, dipentaerythritol pentaacrylate, and any combination thereof. However, the present disclosure is not limited thereto. In some embodiments, an amount of the multifunctional acrylic monomer can be 15 wt %, 20 wt %, or 25 wt %.

An addition of the thiol compound can enhance compatibility between the plurality of the quantum dot particles 11 and the polymerizable polymer 10. Specifically, when the thiol compound is mixed with the plurality of the quantum dot particles 11, the thiol compound is attached onto the surfaces of the quantum dot particles 11, and then a self-assembled structure is formed. Accordingly, the plurality of the quantum dot particles 11 can be more uniformly dispersed in the polymerizable polymer 10. Therefore, the addition of the thiol compound can enhance the dispersity of the quantum dot particles 11 in the polymerizable polymer 10.

When the sheath layer of the quantum dot particles 11 contains cadmium, a bonding between a thiol group of the thiol compound and the quantum dot particles 11 can be formed, thereby enhancing the dispersity of the quantum dot particles 11 in the polymerizable polymer 10. In some embodiments, an amount of the thiol compound can be 10 wt %, 15 wt %, 20 wt %, 25 wt %, 30 wt %, 35 wt %, 40 wt %, 45 wt %, 50 wt %, or 55 wt %.

An addition of the monofunctional acrylic monomer can also enhance the dispersity of the quantum dot particles 11 in the polmerizable polymer 10, and a cost of the monofunctional acrylic monomer is lower than a cost of the thiol compound. Therefore, a balance between the cost and the dispersity of the quantum dot particles 11 can be achieved by adjusting the amounts of the thiol compound and the monofunctional acrylic monomer. In an exemplary embodiment, a total amount of the thiol compound and the monofunctional acrylic monomer ranges from 45 wt % to 75 wt %.

The monofunctional acrylic monomer is selected from the group consisting of: dicyclopentadienyl methacrylate, triethylene glycol ethyl ether methacrylate, alkoxylated lauryl acrylate, isobornyl methacrylate, lauryl methacrylate, stearate methacrylate, lauryl acrylate, isobornyl acrylate, diallyl terephthalate, acrylomorpholine, tridecyl acrylate, caprolactone acrylate, octylphenol acrylate, and alkoxylated acrylates. Preferably, the monofunctional acrylic monomer is isobornyl acrylate, acrylomorpholine, and any combination thereof. However, the present disclosure is not limited thereto. In some embodiments, an amount of the monofunctional acrylic monomer can be 2.5 wt %, 5 wt %, 10 wt %, 15 wt %, 20 wt %, 25 wt %, 30 wt %, 35 wt %, 40 wt %, 45 wt %, 50 wt %, 55 wt %, or 60 wt %.

An addition of the allyl monomer can enhance thermal stability of the polymerizable polymer 10. In this way, the quantum dot particles 11 can be prevented from absorbing heat energy transformed from a part of the blue light (which can cause generation of free radicals due to deterioration of the polymerizable polymer 10 and affect weather resistance of the quantum dots). For example, the allyl monomer can be selected from the group consisting of: diallyl terephthalate, diallyl phthalate, diallyl carbonate, diallyl oxalate, diallyl isophthalate, and any combination thereof. Preferably, the allyl monomer is diallyl terephthalate. However, the present disclosure is not limited thereto. In some embodiments, an amount of the allyl monomer can be 10 wt % or 15 wt %.

The photoinitiator can be used to absorb light energy (e.g., ultraviolet light) and generate free radicals, cations, or anions, so as to initiate a polymerization reaction. In some embodiments, the photoinitiator can be selected from the group consisting of: 1-hydroxycyclohexyl phenyl ketone, 2-hydroxy-2-methylpropiophenone, benzoyl isopropanol, tribromomethyl phenyl sulfone, and diphenyl(2, 4, 6-trimethylbenzoyl)phosphine oxide. Preferably, the photoinitiator can be 1-hydroxycyclohexyl phenyl ketone, 2-hydroxy methylpropiophenone, or a combination thereof. However, the present disclosure is not limited thereto. In some embodiments, an amount of the photoinitiator can be 2 wt %, 3 wt %, or 4 wt %.

An addition of the scattering particles can help scatter light generated by the quantum dots, such that the optical film manufactured from the quantum dot composite 1 can generate a uniform light beam. It should be noted that, when a weight amount of the scattering particles is lower than 2 wt %, a haze of the quantum dot composite 1 is insufficient. When the weight amount of the scattering particles is higher than 10 wt %, the dispersity of the quantum dot particles 11 is negatively influenced.

The scattering particles can be microbeads having a particle size of from 0.5 μm to 20 μm. A material of the microbeads can be selected from the group consisting of: acrylic, silicon dioxide, germanium dioxide, titanium dioxide, zirconium dioxide, aluminum oxide, and polystyrene.

It should be noted that the polymerizable polymer 10 can further include an inhibitor. An addition of the inhibitor can control a duration for the quantum dot composite 1 to solidify, so that an easy operation can be achieved. If the inhibitor is absent from the polymerizable polymer 10, the polymerizable polymer 10 may be solidified before being uniformly mixed with quantum dot particles 11, which can result in a poor quantum dot material. A weight amount of the inhibitor in the polymerizable polymer 10 ranges from 0.05 wt % to 2 wt %.

Referring to FIG. 3, an optical film m1 is provided in the present disclosure. The optical film m1 includes a quantum dot layer 1′, a first substrate layer 2, and a second substrate layer 3. In the present embodiment, the optical film m1 includes the quantum dot layer 1′, the first substrate layer 2, and the second substrate layer 3, and the quantum dot layer 1′ is disposed between the first substrate layer 2 and the second substrate layer 3. In other words, the quantum dot layer 1′ has a first surface 1a and a second surface 1b that are opposite to each other. The first substrate layer 2 is connected with the first surface 1a, and the second substrate layer 3 is connected with the second surface 1b.

The quantum dot layer 1′ can be formed by solidification of the above-mentioned quantum dot composite 1. The specific components of the quantum dot composite 1 are as mentioned previously and will not be reiterated herein. Specifically, the quantum dot composite 1 is disposed on the first substrate layer 2, and then the second substrate layer 3 is disposed on the quantum dot composite 1, so as to form a laminate structure. In an exemplary embodiment, a thickness of the quantum dot layer 1′ ranges from 20 μm to 350 μM.

Subsequently, a solidification step is implemented, such that the quantum dot layer 1′ is formed by solidification of the quantum dot composite 1 in the laminate structure. The quantum dot layer 1′ can be formed from the quantum dot composite 1 through light solidification or thermal solidification. Moreover, in the solidification step, the laminate structure can be exposed to an ultraviolet light, so as to facilitate the quantum dot composite 1 to solidify and form into the quantum dot layer 1′. Accordingly, the quantum dot layer 1′ includes a polymer 10′ formed from the polymerizable polymer 10 and the plurality of the quantum dot particles 11 dispersed in the polymer 10′.

Materials of the first substrate layer 2 and the second substrate layer 3 can be polyester, such as polyethylene terephthalate (PET), polypropylene terephthalate (PPT), polybutylene terephthalate (PBT), polyethylene naphthalate (PEN), polybutylene naphthalate (PBN), polycyclohexanedimethanol terephthalate (PCT), polycarbonate (PC), and polyarylate. In an exemplary embodiment, the polyester is polyethylene terephthalate. A thickness of each of the first substrate layer 2 and the second substrate layer 3 ranges from 20 μm to 125 μm.

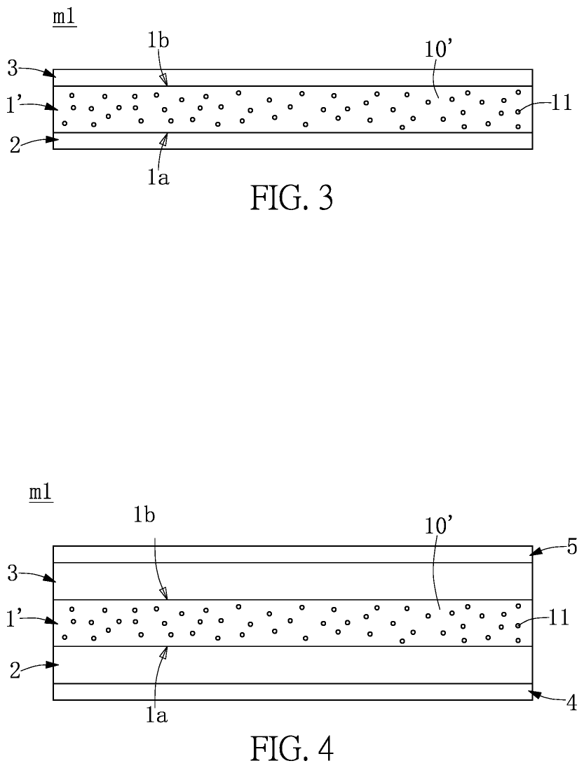

Referring to FIG. 4, another optical film m1 is provided in the present disclosure. The optical film m1 includes a quantum dot layer 1′, a first substrate layer 2, a second substrate layer 3, a first protection layer 4, and a second protection layer 5. The quantum dot layer 1′ is disposed between the first substrate layer 2 and the second substrate layer 3. The first protection layer 4 is formed on the first substrate layer 2. The second protection layer 5 is formed on the second substrate layer 3.

The specific components and structure of the quantum dot layer 1′, the first substrate layer 2, and the second substrate layer 3 are mentioned previously and will not be reiterated herein. The first protection layer 4 and the second protection layer 5 can prevent the optical film m1 from being worn or scratched during transportation. The first protection layer 4 and the second protection layer 5 are each formed from a composite material. A thickness of each of the first protection layer 4 and the second protection layer 5 ranges from 3 μm to 10 μm.

In an exemplary embodiment, the composite material can include propylene glycol, ethyl acetate, toluene, urethane acrylate, acryl morpholine, a thiol compound, a leveling agent, a photoinitiator, and silica powder. The leveling agent can be tetraacrylic functional polydimethylsiloxane or tripropylene glycol diacrylate. However, the present disclosure is not limited thereto.

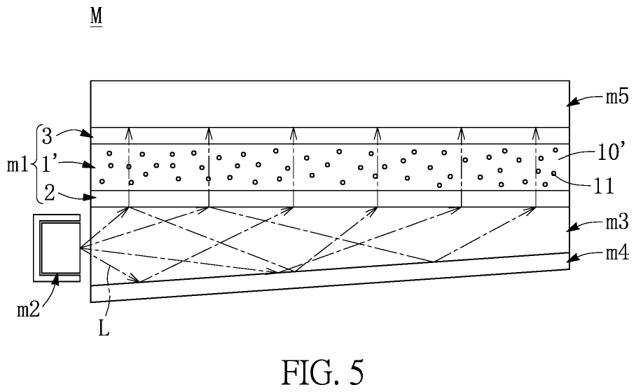

Referring to FIG. 5, a backlight module M is provided in the present disclosure. The backlight module M includes the optical film m1, a light emitting unit m2, a first light guide unit m3, a reflective unit m4, and a second light guide unit m5.

The optical film m1 can be the optical film m1 shown in FIG. 3, which includes a quantum dot layer 1′, a first substrate layer 2, and a second substrate layer 3. The quantum dot layer 1′ is disposed between the first substrate layer 2 and the second substrate layer 3. Materials of the quantum dot layer 1′, the first substrate layer 2, and the second substrate layer 3 are mentioned previously and will not be reiterated herein.

The light emitting unit m2 is disposed adjacent to the optical film m1, so that a light beam L generated by the light emitting unit m2 can be projected to the optical film m1. In addition, an intensity of the light beam L is not less than 10000 cd/m². After entering the optical film m1, a part of the light beam L excites the quantum dot particles 11 of the quantum dot layer 1′, so as to produce an excited light beam. A wavelength band of the excited light beam is different from a wavelength band of the light beam L. In other words, a mixed light beam (including the light beam L and the excited light beam) is produced after the light beam L generated by the light emitting unit m2 passes through the quantum dot layer 1′.

The first light guide unit m3 is connected with the first substrate layer 2 of the optical film m1. In some embodiments, the first light guide unit m3 is fixed onto the optical film m1 via an optical adhesive layer. In an exemplary embodiment, the first light guide unit m3 is a right trapezoid. The first light guide unit m3 is connected with the optical film m1 via its leg that connects two right corners, and is connected with the light emitting unit m2 via its longer base. Therefore, the light beam L generated by the light emitting unit m2 passes through the first light guide unit m3, and is then projected to the optical film m1.

The reflective unit m4 is connected with the first light guide unit m3, and is connected with another leg of the first light guide unit m3. The reflective unit m4 helps projection of the light beam L to the optical film m1.

The second light guide unit m5 is connected with the second substrate layer 3 of the optical film m1, so as to disperse or converge the mixed light beam. In some embodiments, the second light guide unit m5 can be fixed onto the optical film m1 via an optical adhesive layer.

It should be noted that the structure mentioned above is provided only to illustrate one configuration of the backlight module of the present disclosure. The relative arrangements of the first light guide unit m3, the reflective unit m4, and the second light guide unit m5 are not limited thereto. The backlight module can optionally omit one or two of the first light guide unit m3, the reflective unit m4, and the second light guide unit m5.

To prove advantages of the quantum dot composite 1, the optical film m1, and the backlight module M of the present disclosure, the quantum dot composites of Examples 1 to 5 and Comparative Example 1 are prepared according to components listed in Table 1. The quantum dot composite listed in Table 1, a PET substrate, and the composite material listed in Table 2 are used to manufacture the optical film m1 as shown in FIG. 3. A transmittance and a haze of the optical film m1 and thicknesses of the quantum dot layer 1′ and the substrate layers (the first substrate layer and the second substrate layer) are listed in Table 3.

The optical film m1 and the light emitting unit m2 are assembled with the first light guide unit m3, the reflective unit m4, and the second light guide unit m5, so as to form the backlight module M as shown in FIG. 5. Brightness and weather resistance of the backlight module M are measured, and test results are listed in Table 4.

In Table 1, the quantum dot particles used in Examples 1, 2, and 5 and Comparative Example 1 include red quantum dot particles having a particle size of 11 nm (a diameter of the core layer being 4 nm, a thickness of the alloy layer being 2 nm, and a thickness of the sheath layer being 2.5 nm) and green quantum dot particles having a particle size of 15 nm (a diameter of the core layer being 3 nm, a thickness of the alloy layer being 2 nm, and a thickness of the sheath layer being 4 nm). The quantum dot particles used in Examples 3 and 4 include red quantum dot particles having a particle size of 17 nm (a diameter of the core layer being 4 nm, a thickness of the alloy layer being 1 nm, and a thickness of the sheath layer being 5.5 nm) and green quantum dot particles having a particle size of 25 nm (a diameter of the core layer being 3 nm, a thickness of the alloy layer being 2 nm, and a thickness of the sheath layer being 9 nm).

In Table 4, brightness of the mixed light beam that is generated by the backlight module with a blue light source (power: 12 W; color coordinate: (x=0.155, y=0.026); wavelength: 450 nm; FWHM: 20 nm) is measured by a spectrophotometer (model: SR-3AR). The weather resistance of the backlight module is tested by having the backlight module exposed to a blue light with an intensity of 1000 cd/m² for 1000 hours, so as to measure a change of the color coordinate. The evaluation of “PASS” represents that a change of “x” and “y” in the color coordinate is less than 0.01. The evaluation of “FAIL” represents that the change of one of “x” and “y” in the color coordinate is greater than or equal to 0.01.

TABLE 1
Quantum dot composite

| | | | | | | | | | | | Comparative | |
|---|---|---|---|---|---|---|---|---|---|---|---|---|
| | Example 1 | | Example 2 | | Example 3 | | Example 4 | | Example 5 | | Example 1 | |
| Quantum dot particles | 4.50 | wt % | 4.50 | wt % | 4.71 | wt % | 12.96 | wt % | 4.00 | wt % | 4.50 | wt % |
| Weight ratio of red quantum | 1/10 | | 1/10 | | 1/5 | | 1/6 | | 1/10 | | 1/10 | |
| dot particles to green quantum | | | | | | | | | | | | |
| dot particles | | | | | | | | | | | | |
| Multifunctional acrylic | 25 | wt % | 25 | wt % | 25 | wt % | 10.93 | wt % | 25 | wt % | 25 | wt % |
| monomer | | | | | | | | | | | | |
| Thiol compound | 40 | wt % | 10 | wt % | 10 | wt % | 10 | wt % | 40 | wt % | — | |
| Monofunctional acrylic | 2.70 | wt % | 32.70 | wt % | 42.59 | wt % | 61.12 | wt % | 2.20 | wt % | 42.70 | wt % |
| monomer | | | | | | | | | | | | |
| Allyl monomer | 17.8 | wt % | 17.8 | wt % | 7.7 | wt % | — | | 17.8 | wt % | 17.8 | wt % |
| Photoinitiator | 3 | wt % | 3 | wt % | 3 | wt % | 3 | wt % | 3 | wt % | 3 | wt % |
| Scattering particles | 7 | wt % | 7 | wt % | 7 | wt % | 2 | wt % | 7 | wt % | 7 | wt % |

TABLE 2
Composite material

| | | |
|---|---|---|
| Propylene glycol methyl ether | 50 | wt % |
| Ethyl acetate | 22.5 | wt % |
| Toluene | 2.5 | wt % |
| Silicon dioxide powder | 0.63 | wt % |
| Urethane acrylate | 13 | wt % |
| Acrylomorpholine | 8.75 | wt % |
| Thiol compound | 1.25 | wt % |
| Leveling agent | 0.38 | wt % |
| Photoinitiator | 1 | wt % |

TABLE 3
Optical film

| | | | | | | Comparative |
|---|---|---|---|---|---|---|
| | Example 1 | Example 2 | Example 3 | Example 4 | Example 5 | Example 1 |
| Thickness of the quantum dot layer | 80 μm | 80 μm | 80 μm | 30 μm | 300 μm | 80 μm |
| Thickness of the substrate layer | 50 μm | 50 μm | 50 μm | 25 μm | 100 μm | 50 μm |
| Transmittance | 71.35% | 75.26% | 79.91% | 86.98% | 55.63% | 76.56% |
| Haze | 98.64% | 98.72% | 97.85% | 48.98% | 98.99% | 98.26% |

TABLE 4
Backlight module

| | | | | | | Comparative |
|---|---|---|---|---|---|---|
| | Example 1 | Example 2 | Example 3 | Example 4 | Example 5 | Example 1 |
| Brightness (cd/m²) | 3658 | 3173 | 3072 | 2210 | 3524 | 3075 |
| Color coordinate (x, y) | (0.3052, | (0.2785, | (0.2015, | (0.1728, | (0.3401, | (0.2943, |
| (T = 0) | 0.2148) | 0.1965) | 0.1300) | 0.0640) | 0.2685) | 0.1879) |
| Color coordinate (x, y) | (0.3002, | (0.2915, | (0.2073, | (0.1774, | (0.3326, | (0.2765, |
| (T = 1000 hr) | 0.2079) | 0.1897) | 0.1317) | 0.0605) | 0.2599) | 0.1573) |
| Resistant reliability | PASS | PASS | PASS | PASS | PASS | FAIL |

According to results in Table 3, the thickness of the optical film ranges from 100 μm to 520 μm, the transmittance of the optical film ranges from 50% to 90%, and the haze of the optical film ranges from 45% to 99%. When the thickness of the optical film ranges from 100 μm to 150 μm, the transmittance of the optical film ranges from 85% to 90%, and the haze of the optical film ranges from 40% to 60%. When the thickness of the optical film ranges from 150 μm to 520 μm, the transmittance of the optical film ranges from 55% to 85%, and the haze of the optical film ranges from 60% to 99%. According to various requirements, the transmittance and the haze of the optical film can be adjusted by changing the thicknesses of the quantum dot layer and the substrate layers.

According to the results in Table 4, the brightness of the light beam generated by the backlight module of the present disclosure ranges from 2000 cd/m² to 3800 cd/m². In addition, a high-intensity blue light source (not less than 1000 cd/m²) can be used in the backlight module of the present disclosure, and the backlight module of the present disclosure can have good weather resistance.

### Beneficial Effects of the Embodiments

In conclusion, in the quantum dot composite, the optical film, and the backlight module provided by the present disclosure, by virtue of “a particle size of the plurality of the quantum dot particles ranging from 8 nm to 30 nm” and “the thiol compound self-assembled on surfaces of the plurality of the quantum dot particles,” the quantum dot composite can have improved weather resistance and can be applied in the display that is used to convert blue light.

Further, by virtue of “a concentration of the quantum dot particles in the quantum dot composite ranging from 4 wt % to 15 wt %”, the brightness of the light beam generated by the backlight module can be enhanced.

Further, by virtue of “the quantum dot composite further including a monofunctional acrylic monomer”, the dispersity of the plurality of the quantum dot particles in the quantum dot composite can be enhanced.

Further, by virtue of “each of the quantum dot particles having a core layer and a sheath layer, and a thickness of the sheath layer ranging from 2.5 nm to 12 nm”, the quantum dot particles can have improved resistance to blue light.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A quantum dot composite, comprising a polymerizable polymer and a plurality of quantum dot particles dispersed in the polymerizable polymer, wherein a particle size of the plurality of the quantum dot particles ranges from 8 nm to 30 nm; wherein, based on a total weight of the polymerizable polymer being 100 wt %, the polymerizable polymer includes:
10 wt % to 30 wt % of a multifunctional acrylic monomer,
8 wt % to 60 wt % of a thiol compound self-assembled on surfaces of the plurality of the quantum dot particles, and
1 wt % to 5 wt % of a photoinitiator.

2. The quantum dot composite according to claim 1, wherein each of the quantum dot particles has a core layer and a sheath layer, and a thickness of the sheath layer ranges from 2.5 nm to 12 nm.

3. The quantum dot composite according to claim 2, wherein a material of the sheath layer contains cadmium.

4. The quantum dot composite according to claim 2, wherein each of the quantum dot particles further has an alloy layer disposed between the core layer and the sheath layer.

5. The quantum dot composite according to claim 1, wherein the quantum dot particles include red quantum dots with a size ranging from 8 nm to 20 nm and green quantum dots with a size ranging from 11 nm to 30 nm.

6. The quantum dot composite according to claim 1, wherein the quantum dot particles include red quantum dots and green quantum dots, and a weight amount of the green quantum dots is 4 times to 10 times larger than a weight amount of the red quantum dots.

7. The quantum dot composite according to claim 1, wherein a concentration of the quantum dot particles in the quantum dot composite ranges from 4 wt % to 15 wt %.

8. The quantum dot composite according to claim 1, wherein the thiol compound is selected from the group consisting of: 3-mercaptopropionic acid, propyl 3-mercaptopropionate, ethyl 3-mercaptopropionate, butyl 3-mercaptopropionate, 3-mercaptopropionitrile, and any combination thereof.

9. The quantum dot composite according to claim 1, wherein the multifunctional acrylic monomer is selected from the group consisting of: pentaerythritol tetraacrylate, pentaerythritol triacrylate, and any combination thereof.

10. The quantum dot composite according to claim 1, further comprising a monofunctional acrylic monomer, wherein, based on the total weight of the polymerizable polymer being 100 wt %, an amount of the monofunctional acrylic monomer ranges from 2.5 wt % to 65 wt %; wherein the monofunctional acrylic monomer is selected from the group consisting of: isobornyl acrylate, acrylomorpholine, and any combination thereof.

11. The quantum dot composite according to claim 1, further comprising an allyl monomer, wherein, based on the total weight of the polymerizable polymer being 100 wt %, an amount of the allyl monomer ranges from 5 wt % to 20 wt %; wherein the allyl monomer is selected from the group consisting of: diallyl terephthalate, diallyl phthalate, diallyl carbonate, diallyl oxalate, diallyl isophthalate, and any combination thereof.

12. The quantum dot composite according to claim 1, further comprising scattering particles, wherein, based on the total weight of the polymerizable polymer being 100 wt %, an amount of the scattering particles ranges from 2 wt % to 10 wt %.

13. An optical film, comprising: a quantum dot layer, a first substrate layer, and a second substrate layer, wherein the quantum dot layer is disposed between the first substrate layer and the second substrate layer, the quantum dot layer is formed by solidification of a quantum dot composite, the quantum dot composite includes a polymerizable polymer and a plurality of quantum dot particles dispersed in the polymerizable polymer, and a particle size of the plurality of the quantum dot particles ranges from 8 nm to 30 nm; wherein, based on a total weight of the polymerizable polymer being 100 wt %, the polymerizable polymer includes:
10 wt % to 30 wt % of a multifunctional acrylic monomer,
8 wt % to 60 wt % of a thiol compound self-assembled on surfaces of the plurality of the quantum dot particles, and
1 wt % to 5 wt % of a photoinitiator.

14. The optical film according to claim 13, wherein materials of the first substrate layer and the second substrate layer include polyethylene terephthalate, and a thickness of each of the first substrate layer and the second substrate layer ranges from 20 μm to 125 μm.

15. The optical film according to claim 13, wherein a thickness of the quantum dot layer ranges from 20 μm to 350 μm.

16. The optical film according to claim 13, further comprising a protection layer, wherein the protection layer is disposed on each of the first substrate layer and the second substrate layer.

17. A backlight module, comprising:
an optical film, wherein the optical film includes:
a quantum dot layer having a first surface and a second surface, wherein the quantum dot layer is formed by solidification of a quantum dot composite, the quantum dot composite includes a polymerizable polymer and a plurality of quantum dot particles dispersed in the polymerizable polymer, and a particle size of the plurality of the quantum dot particles ranges from 8 nm to 30 nm; wherein, based on a total weight of the polymerizable polymer being 100 wt %, the polymerizable polymer includes:
10 wt % to 30 wt % of a multifunctional acrylic monomer,
8 wt % to 60 wt % of a thiol compound self-assembled on surfaces of the plurality of the quantum dot particles, and
1 wt % to 5 wt % of a photoinitiator;
a first substrate layer connected with the first surface of the quantum dot layer, and
a second substrate layer connected with the second surface of the quantum dot layer;
a light emitting unit disposed adjacent to the optical film, wherein the light emitting unit generates a light beam that is projected to the optical film, and an intensity of the light beam is not less than 10000 cd/m²;
a first light guide unit connected with the first substrate layer of the optical film; and
a second light guide unit connected with the second substrate layer of the optical film.
